(19) United States
(12) Patent Application Publication
(10) Pub. No.: US 2010/0117959 A1
(43) Pub. Date: May 13, 2010

(54) MOTION SENSOR-BASED USER MOTION RECOGNITION METHOD AND PORTABLE TERMINAL USING THE SAME

(75) Inventors: Hyun Su HONG, Seongnam-si (KR); Woo Jin Jung, Yongin-si (KR); Sun Young Park, Suwon-si (KR); Mi Jin Jeong, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/615,691

(22) Filed: Nov. 10, 2009

(30) Foreign Application Priority Data
Nov. 10, 2008 (KR) 10-2008-0111228
Jan. 30, 2009 (KR) 10-2009-0007314

(51) Int. Cl. G06F 3/033

(52) U.S. Cl. 345/158

(57) ABSTRACT

A motion sensor-based user motion recognition method and portable terminal having a motion sensor is disclosed. The method recognizes user motions in a portable terminal. At least one parameter value is extracted from at least one user motion applied to the portable terminal. A reference parameter value serving as a user motion recognition reference is established according to at least one extracted parameter value. The established reference parameter value is stored.

### CROSS REFERENCE TO RELATED APPLICATIONS

This application claims priority from and the benefit of Korean Patent Application No. 10-2008-0111228, filed on Nov. 10, 2008, and Korean Patent Application No. 10-2009-0007314, filed on Jan. 30, 2009, which are hereby incorporated by reference for all purposes as if fully set forth herein.

### BACKGROUND OF THE INVENTION

1. Field of the Invention

Exemplary embodiments of the present invention relate to motion sensor based technology, and more particularly, to a method for recognizing user motions by considering user motion patterns and a portable terminal using the method.

2. Discussion of the Background

In recent years, the number of people using portable terminals has rapidly increased, and portable terminals serve as an essential tool for modern life. Along with an increase in the number of portable terminals, related user interface technology has also been developed.

A conventional user interface is mainly implemented with a keypad installed in the portable terminals. Recently, a user interface technology using a touch sensor or a tactile sensor has been developed. In particular, a user interface technology using a motion sensor has been also developed that can recognize user motions and be applied to portable terminals. If a user applies a motion to his/her portable terminal having a motion sensor, the portable terminal recognizes the user motion and performs a corresponding function thereto.

Conventional portable terminals having a motion sensor, however, recognize user motions according to a standardized reference without considering the features of user motions. For example, user motions may be different according to user's sex, age, etc, and thus the input values corresponding to user motions may also differ from each other. Conventional portable terminals do not consider these factors and instead request input motion values according to a predetermined reference. In that case, conventional portable terminals recognize only motion input values corresponding to a certain area. Thus, they have a relatively low rate of motion recognition and may make users feel inconvenienced.

A method is required to perform user motion recognition that takes users' characteristic motion patterns into consideration.

### SUMMARY OF THE INVENTION

Exemplary embodiments of the present invention relate to a method that can recognize user motions by considering users' characteristic motion patterns.

Exemplary embodiments of the present invention also provide a portable terminal adapted to the method that can recognize user motions by considering users' characteristic motion patterns.

Additional features of the invention will be set forth in the description which follows, and in part will be apparent from the description, or may be learned by practice of the invention.

An exemplary embodiment of the present invention discloses a method for recognizing user motions in a portable terminal having a motion sensor. The method includes extracting at least one parameter value from at least one user motion input into the portable terminal. The method includes establishing a reference parameter value serving as a user motion recognition reference, based on the extracted parameter value. The method includes storing the established reference parameter value.

An exemplary embodiment of the present invention also discloses a portable terminal including: a pattern analyzing part for extracting a parameter value of an input user motion; a pattern learning part for establishing a reference parameter value using the extracted parameter value; and a storage unit for storing the established reference parameter value.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram describing a method for recognizing user motions according to an exemplary embodiment of the present invention.

FIG. 2 is a schematic block diagram illustrating a portable terminal that recognizes user motions according to an exemplary embodiment of the present invention.

FIG. 3 is a flow chart describing a motion learning process related to a tapping motion during the user motion recognition according to a first exemplary embodiment of the present invention.

FIG. 4 is a flow chart describing a motion learning process related to a snapping motion during the user motion recognition according to the first exemplary embodiment of the present invention.

FIG. 5 is a flow chart describing a motion learning process related to a shaking motion during the user motion recognition according to the first exemplary embodiment of the present invention.

FIG. 6A, FIG. 6B, and FIG. 6C are views illustrating an acceleration graph with respect to an input motion during the motion learning process according to an exemplary embodiment of the present invention.

FIG. 7A is a view illustrating an acceleration graph with respect to an input motion during the motion learning process according to an exemplary embodiment of the present invention.

FIG. 7B is a view illustrating an acceleration graph with respect to an input motion during the motion learning process according to an exemplary embodiment of the present invention.

FIG. 8A is a view illustrating a screen that receives the input of a motion during the motion learning process according to an exemplary embodiment of the present invention.

FIG. 8B is a view illustrating the location of a portable terminal that receives an input during the motion learning process according to an exemplary embodiment of the present invention.

FIG. 9A is a view illustrating screens that show a motion requested during the motion learning process according to an exemplary embodiment of the present invention.

FIG. 9B is a view illustrating screens that show a motion requested during the motion learning process according to an exemplary embodiment of the present invention.

FIG. 10 is a view that describes the axes of motion directions according to an exemplary embodiment of the present invention.

FIG. 11 is a diagram describing a method for recognizing user motions according to a second exemplary embodiment of the present invention.

FIG. 12 is a flow chart describing a process for establishing a motion recognition reference in the method for recognizing user motions according to the second exemplary embodiment of the present invention.

FIG. 13 is a view illustrating a distribution graph of motion intensity according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element or layer is referred to as being “on” or “connected to” another element or layer, it can be directly on or directly connected to the other element or layer, or intervening elements or layers may be present. In contrast, when an element or layer is referred to as being “directly on” or “directly connected to” another element or layer, there are no intervening elements or layers present.

Prior to further explanation of the exemplary embodiments of the present invention, some terminology will be defined as follows.

The term ‘a set of reference parameter values’ refers to a set of parameter values used as reference values to recognize a user motion. The set of reference parameter values is established through a learning process of the device, and stored according to respective motion patterns (tapping, snapping, shaking, etc.). In an exemplary embodiment of the present invention, if a portable terminal receives a user motion, it recognizes the user motion based on the set of reference parameter values stored therein.

In an exemplary embodiment of the present invention, the term ‘learning process’ refers to a process for the device to learn a user's characteristic motion patterns and to establish a set of corresponding reference parameter values in the device, for example, a portable terminal. The set of reference parameter values, established through the learning process, is used as a reference to recognize the user motion in a motion recognition mode of the portable terminal.

Hereinafter, exemplary embodiments of the present invention are described in detail with reference to the accompanying drawings. The same reference numbers are used throughout the drawings to refer to the same or similar parts. Detailed descriptions of well known functions and structures incorporated herein may be omitted to avoid obscuring the subject matter of the present invention.

Although the exemplary embodiments according to the present invention are explained based on a portable terminal, it should be understood that the present invention is not limited to such embodiments. It will be appreciated that the motion sensor-based user motion recognition method and device described with reference to the exemplary embodiment of a portable terminal can be applied to all information communication devices, multimedia devices, and their applications that include a motion sensor. Examples of the portable terminal are a mobile communication terminal, a portable multimedia player (PMP), a personal digital assistant (PDA), a smart phone, an MP3 player, etc.

In an exemplary embodiment of the present invention, it should be understood that the set of parameter values may be composed of one parameter value or a plurality of parameter values.

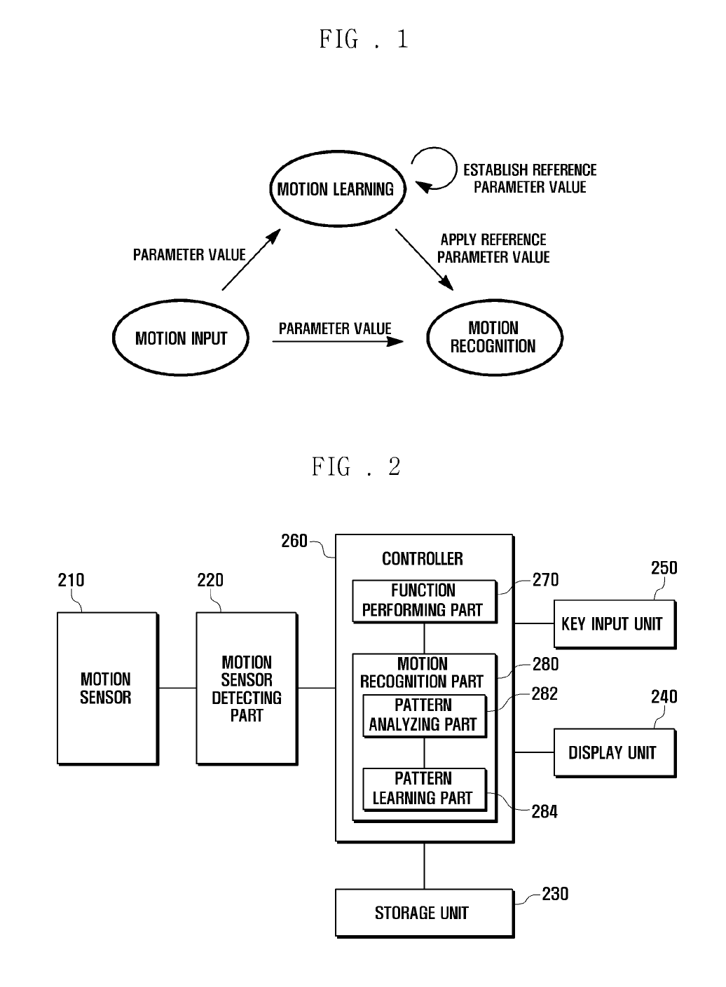

FIG. 1 is a view describing a concept of a method for recognizing user motions, according to an exemplary embodiment of the present invention.

Referring to FIG. 1, a motion input process is performed in such a way that a user inputs his/her motions into a portable terminal in a learning mode, the input user motions are analyzed, and parameter values are extracted from the analysis and transmitted to a motion learning process.

The parameter values are used to establish a reference parameter value in the motion learning process.

A motion recognition process is performed in such a way that, after the reference parameter value has been established, the user inputs his/her motions into the portable terminal in a motion recognition mode, and the portable terminal recognizes the input user motions using the established reference parameter value. That is, since the portable terminal recognizes the reference parameter value that has already been established by reflecting a user's characteristic motion patterns through the learning process, it can more precisely recognize user motions.

FIG. 2 is a schematic block diagram illustrating a portable terminal that recognizes user motions, according to an exemplary embodiment of the present invention.

Referring to FIG. 2, a motion sensor 210 serves to sense motions that a user applies to a portable terminal. In an exemplary embodiment of the present invention, the motion sensor 210 may be implemented with an acceleration sensor, a gyro sensor, a terrestrial magnetic sensor, etc. It will be appreciated that the motion sensor 210 may include all types of sensors that can recognize the user's motions. If the user inputs a motion to the portable terminal, the motion sensor 210 senses the input motion, generates a sensed signal, and then outputs it to a motion recognition part 280 via a motion sensor detecting part 220. The motion sensor detecting part 220 interfaces between the motion sensor 210 and the motion recognition part 280.

A storage unit 230 serves to store an application program for controlling the operations of the portable terminal and data generated as the portable terminal is operated. In an exemplary embodiment of the present invention, the storage unit 230 stores a set of reference parameter values that are established through a learning process. The set of reference parameter values, stored in the storage unit 230, are used as a reference value to recognize user motions that are input in a motion recognition mode.

A display unit 240 displays menus of the portable terminal, input data, information regarding function settings, a variety of information, etc. It is preferable that the display unit 240 is implemented with a liquid crystal display (LCD). In that case, the display unit 240 may further include an apparatus for controlling the LCD, a video memory for storing video data, LCD devices, etc. In an exemplary embodiment of the present invention, to perform a learning process, the display unit 240 may display a demonstration of a user motion requested of a user before the user inputs the motion. The user inputs motions according to the instructions displayed on the display unit 240, and thus this process prevents incorrect input by the user or confusion.

A key input unit 250 receives a user's key operation signals for controlling the portable terminal and outputs them to a controller 260. The key input unit 250 may be implemented with a keypad or a touch screen.

A controller 260 controls the entire operation of the portable terminal and the signal flow among elements in the portable terminal. The controller 260 may further include a function performing part 270 and a motion recognition part 280.

The function performing part 270 serves to perform functions related to an application. In an exemplary embodiment of the present invention, the application may include a particular program executed in the portable terminal. The application may include a background image displaying function and a screen turning off function if they allow for the recognition of input motions. When an application is executed, the function performing part 270 transmits a motion recognition execution command to the motion recognition part 280. When the function performing part 270 receives a motion recognition signal from the motion recognition part 280, it performs a corresponding function.

The motion recognition part 280 serves to recognize and analyze the input user motion. In an exemplary embodiment of the present invention, the motion recognition part 280 includes a pattern analyzing part 282 and a pattern learning part 284.

The pattern analyzing part 282 extracts sets of parameter values using raw data received from the motion sensor detecting part 220. In a first exemplary embodiment of the present invention, the pattern analyzing part 282 analyzes raw data from the motion sensor detecting part 220 and extracts a set of parameter values during the learning process. After that, the pattern analyzing part 282 outputs the extracted set of parameter values to the pattern learning part 284. In an exemplary embodiment of the present invention, the pattern analyzing part 282 analyzes the patterns of the raw data received from the motion sensor detecting part 220 and determines whether the patterns correspond to requested input motions. The pattern analyzing part 282 extracts a set of parameter values with respect to the motions that correspond to the requested input motions and then outputs the extracted sets of parameter values to the pattern learning part 284. For example, when a tapping learning process is performed, the pattern analyzing part 282 analyzes patterns of the raw data received from the motion sensor detecting part 220 and determines whether the patterns correspond to a tapping motion. The pattern analyzing part 282 extracts sets of parameter values with respect to only tapping motions and then outputs them to the pattern learning part 284. From among the sets of parameter values that are extracted from the input tapping motions, the pattern analyzing part 282 sorts the sets of parameter values for the tapping motions that are determined as a user's effective input and then outputs them to the pattern learning part 284.

In a motion recognition mode, the pattern analyzing part 282 determines whether a set of parameter values, extracted from the input user motion, matches with a set of reference parameter values established as a condition. For example, if a set of reference parameter values is established as a lower threshold of a motion recognition range, the pattern analyzing part 282 compares parameter values, constituting the extracted set of parameter values, with parameter values constituting the set of reference parameter values, respectively. If all parameter values constituting the extracted set of parameter values are greater than all parameter values constituting the set of reference parameter values, the pattern analyzing part 282 notifies the function performing part 270 that the user motion was recognized.

The pattern learning part 284 serves to establish a set of reference parameter values using the sets of parameter values received from the pattern analyzing part 282. The pattern learning part 284 establishes a set of reference parameter values using the average, maximum and minimum of respective parameter values constituting the received sets of parameter values. In an exemplary embodiment of the present invention, the pattern learning part 284 analyzes a distribution graph of respective parameter values constituting the received sets of parameter values, and establishes a set of reference parameter values using parameter values that are densely distributed in the distribution graph. The set of parameters may include parameters, such as motion recognition time, motion time interval, motion intensity, etc.

If the portable terminal according to the exemplary embodiment of the present invention is implemented with a mobile communication terminal, it may further include an RF communication unit. The RF communication unit performs transmission or reception of data for RF communication of the mobile communication terminal. The RF communication unit is configured to include an RF transmitter for up-converting the frequency of transmitted signals and amplifying the transmitted signals and an RF receiver for low-noise amplifying received RF signals and down-converting the frequency of the received RF signals. The RF communication unit receives data via an RF channel and outputs it to the controller 260, and vice versa. In the foregoing description, the configuration of the portable terminal for recognizing user motions has been explained. In the following description, a method for recognizing user motions is explained in detail with reference to the attached figures.

In an exemplary embodiment of the present invention, the ‘user motion’ includes a ‘tapping,’ a ‘snapping,’ and a ‘shaking motion.’ It should be, however, understood that the present invention is not limited to such embodiments.

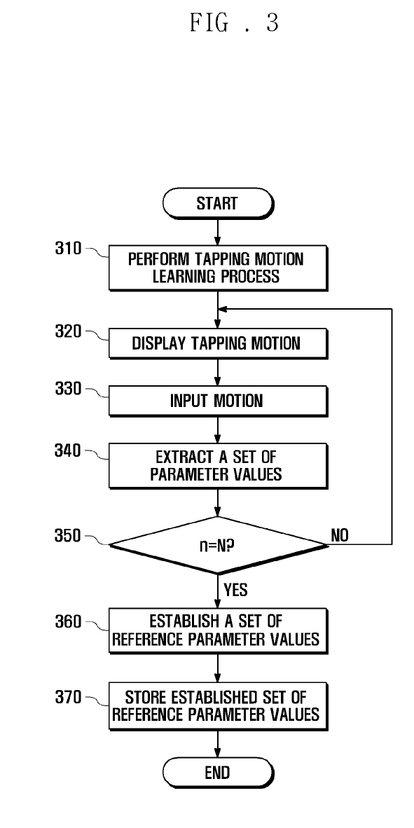

FIG. 3 is a flow chart describing a motion learning process related to a tapping motion during the user motion recognition, according to the first exemplary embodiment of the present invention.

Referring to FIG. 3, when a user inputs a command for executing a tapping motion learning process to a portable terminal, the controller 260 executes the tapping motion learning process (310). The portable terminal includes a motion learning process function as a menu related to motion recognition, through which the user inputs the command for executing a motion learning process by the key input unit 250. In an exemplary embodiment of the present invention, the user may input the command for executing a motion learning process through a motion input.

After inputting the command for executing a motion learning process, the user may input a command for selecting a tapping motion. In an exemplary embodiment of the present invention, the controller 260 controls the display unit 240 to display a screen allowing the user to select a motion connected to a learning process. In this case, the user can select one of the tapping, snapping, and shaking motions.

When the tapping motion learning process is executed at 310, the controller 260 controls the display unit 240 to display a screen showing the execution of the tapping motion (320). The tapping motion execution screen allows the user to input his/her motion. That is, the user inputs a tapping motion according to the screen displayed on the display unit 240.

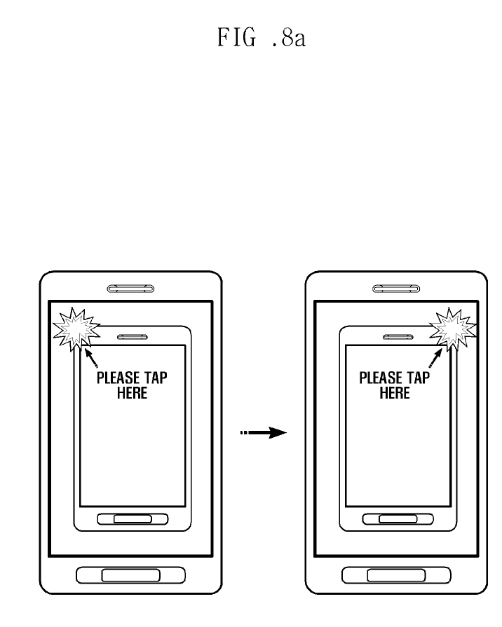

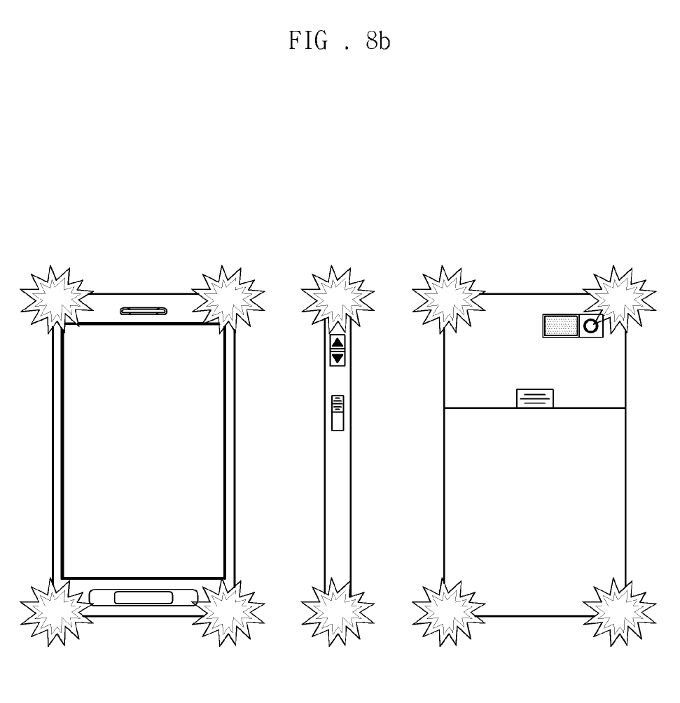

According to the first exemplary embodiment, the screen displayed on the display unit 240 is shown in FIG. 8A. The controller 260 controls the display unit 240 to display the outward appearance of the portable terminal and a position of the outward appearance to be tapped. In an exemplary embodiment of the present invention, the display unit 240 may further display the phrase ‘please tap here’ on its screen.

When the user taps the position displayed on the screen, the pattern analyzing part 282 receives raw data from the motion sensor detecting part 220 and recognizes that the user motion has been input (330). After that, the pattern analyzing part 282 analyzes the received raw data and extracts a set of parameter values (340). The set of parameters may be composed of parameters of motion recognition time and motion intensity from one tapping motion. The set of parameters may also be composed of parameters of a motion recognition time, motion intensity, and motion time interval from two or more tapping motions.

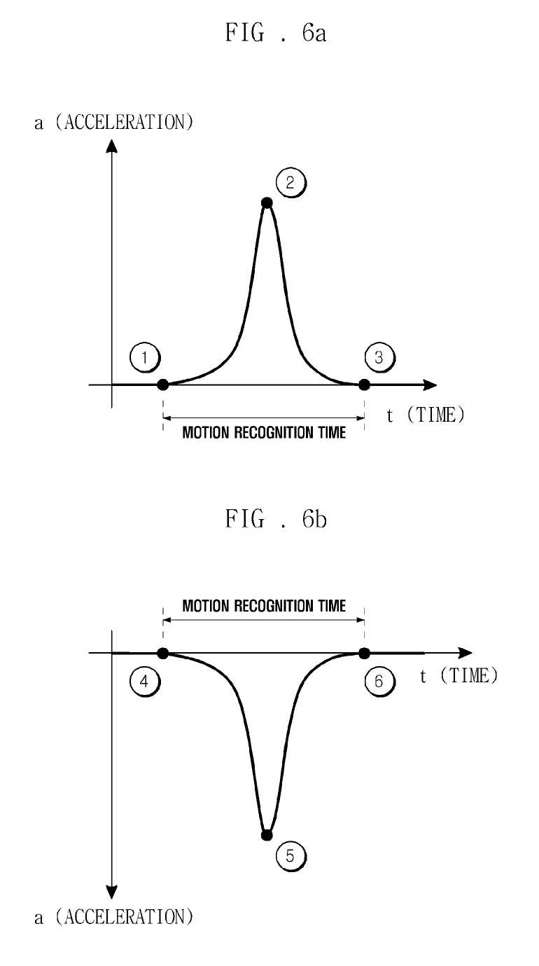

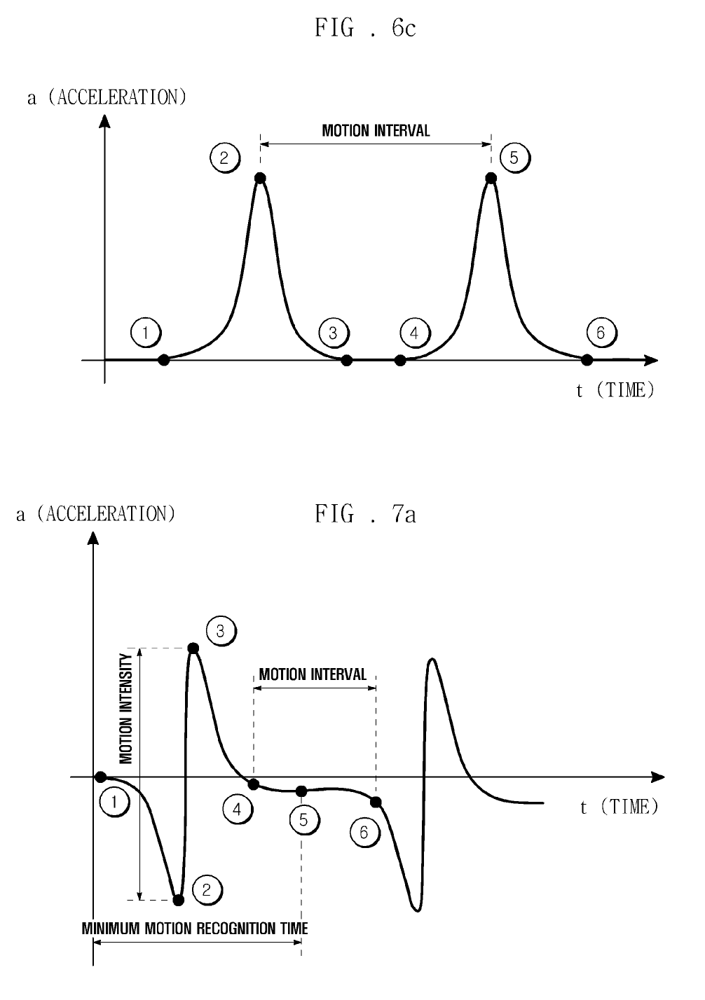

The set of parameters related to the tapping motions is explained with reference to FIG. 6A, FIG. 6B and FIG. 6C. FIG. 6A shows a time (t)—acceleration (a) graph when one tapping motion is applied to the front side (or the display 240) of the portable terminal. FIG. 6B shows a time (t)—acceleration (a) graph when one tapping motion is applied to the rear side (or the opposite side of the display 240) of the portable terminal. The motion intensity is proportion to the magnitude of the acceleration. The motion intensity is measured using the magnitude of the acceleration at point ‘2’ shown in FIG. 6A. The motion recognition time is measured using the time interval between points ‘1’ and ‘3’. Similar to the case of FIG. 6A, the motion intensity is measured using the magnitude of acceleration ‘5’ as shown in FIG. 6B. The motion recognition time is also measured using the time interval between points ‘4’ and ‘6’.

FIG. 6C shows a time (t)—acceleration (a) graph when two tapping motions are applied to the front side of the portable terminal. When two tapping motions occur, the motion intensity is measured by using the magnitude of acceleration at points ‘2’ and ‘5’, and the tapping motion time interval is also measured between the times at points ‘2’ and ‘5’. The motion recognition time is also measured by the times at points ‘1’ and ‘3’, and by the times at points ‘4’ and ‘6’.

The controller 260 determines whether a number of the extracted sets of parameter values, n, is consistent with a predetermined number of the sets of parameter values, N, (350). To establish the set of reference parameter values, a plurality of sets of parameter values may be required. N refers to the number of sets of parameter values to establish the set of reference parameter values. In an exemplary embodiment of the present invention, the pattern analyzing part 282 analyzes the raw data received from the motion sensor detecting part 220 and determines whether the pattern corresponds to a tapping motion. The set of parameter values can be extracted with respect to motions determined as tapping motions. If the set of parameter values extracted from motions other than the tapping motion is used as data to establish a set of reference parameter values, it may be difficult to establish the set of reference parameters suitable for a user. Therefore, the pattern analyzing part 282 extracts a set of parameter values only with respect to a motion determined as a tapping motion, so that the pattern learning part 284 can establish the suitable set of parameter reference parameter values. In an exemplary embodiment of the present invention, the sets of parameter values with respect to motions, determined as a user's effective input, are sorted from among the sets of parameter values extracted from the tapping motion, and then output to the pattern learning part 284. The user's effective input motion refers to a motion having a value equal to or greater than a reference parameter value serving to determine a user's effective motion.

Referring to FIG. 8A, the display unit 240 displays a screen so that the user can tap the left upper position of the front of the portable terminal. When the user taps the left upper position on the screen, the display unit 240 displays a screen so that the user can tap the right upper position of the front of the portable terminal. After that, as shown in FIG. 8B, the display unit 240 displays a screen so that the user can sequentially tap a particular position of the portable terminal. The user sequentially applies tapping motions onto the screen of the display unit 240 until the number of extracted sets of parameter values is equal to the predetermined number of sets of parameter values.

If the controller 260 ascertains that the number of the extracted sets of parameter values, n, is consistent with a predetermined number of the sets of parameter values, N, at 350, it terminates displaying the tapping motion and allows the pattern analyzing part 282 to output the extracted sets of parameter values to the pattern learning part 284. The pattern learning part 284 receives the sets of parameter values and establishes a set of reference parameter values (360). The pattern learning part 284 establishes the set of reference parameter values using the average, maximum, minimum etc. of respective parameter values contained in the sets of parameter values received from the pattern analyzing part 282. For example, if the set of parameter values includes parameters, such as motion intensity, motion recognition time, and motion time interval, the pattern learning part 284 establishes reference parameter values using the average, maximum, and minimum of the motion intensity, motion recognition time, and motion time interval. In an exemplary embodiment of the present invention, the pattern learning part 284 analyzes a distribution graph of parameter values in the sets of parameter values received from the pattern analyzing part 282, sorts the parameter values densely distributed in the distribution graph, and establishes a set of reference parameter values using the sorted parameter values.

The controller 260 stores the established set of reference parameter values in the storage unit 230 and then terminates the learning process (370).

After that, if the user inputs a tapping motion in the portable terminal in a motion recognition mode, the pattern analyzing part 282 extracts a set of parameter values from the input tapping motion, compares the extracted set of parameter values with the set of reference parameter values in the storage unit 230, and then recognizes the user's tapping motion. Comparison between the set of parameter values and the set of reference parameter values is performed by comparing parameter values (motion intensity, motion recognition time, motion time interval, etc.) contained in the set of parameter values with the corresponding reference parameter values contained in the set of reference parameter values, respectively.

If the set of reference parameter values is established as the low threshold of a motion recognition range, the pattern analyzing part 282 can recognize motions only if the input user motion has a value equal to or greater than the low threshold. For example, regarding the motion intensity of the parameter, if the reference parameter value is established as 1 g, the pattern analyzing part 282 can recognize a user motion that is input with an intensity equal to or greater than 1 g. If the minimum of the extracted parameter values is established as the reference parameter value, the reference parameter value can be established as the low threshold for motion recognition.

If the set of reference parameter values serves as a reference value to determine the upper and lower thresholds of a motion recognition range, the pattern analyzing part 282 can recognize user motions only if the input user motions have a value between the upper and lower thresholds. For example, in the case of the motion intensity of the parameters, if the reference parameter value is established as 1 gravity acceleration (g) and the upper and lower thresholds are also established as 1.5 g and 0.5 g, respectively, the pattern analyzing part 282 can only recognize user motions whose intensity is in a range from 0.5 g to 1.5 g. If the pattern learning part 284 calculates the average of the extracted parameter values and then establishes the calculated average as the reference parameter value, the reference parameter value can serve as a reference value to establish the motion recognition range. If the pattern analyzing part 282 recognizes user motions, it outputs them to the function performing part 270. The function performing part 270 performs functions corresponding to the user motions recognized by the pattern analyzing part 282.

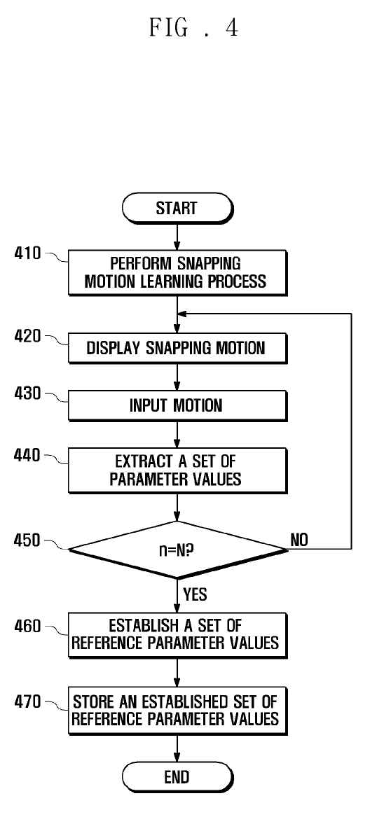

FIG. 4 is a flow chart describing a motion learning process related to a snapping motion during the user motion recognition, according to the first exemplary embodiment of the present invention.

Referring to FIG. 4, when a user inputs a command for executing a snapping motion learning process to a portable terminal, the controller 260 executes the snapping motion learning process (410). In an exemplary embodiment of the present invention, if the user inputs the command for executing a motion learning process, the controller 260 controls the display unit 240 to display a screen allowing the user to select a motion connected to a learning process. In this case, the user can select one of the tapping, snapping, and shaking motions.

When the snapping motion learning process is executed at 410, the controller 260 controls the display unit 240 to display a screen showing the execution of the snapping motion (420). The user inputs a snapping motion according to the screen displayed on the display unit 240.

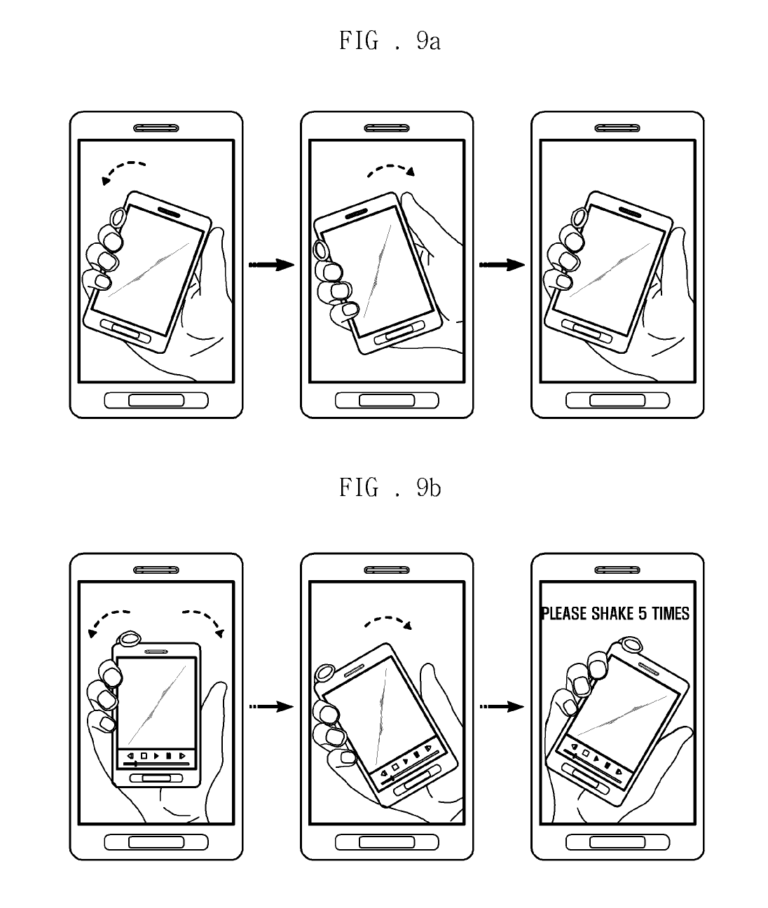

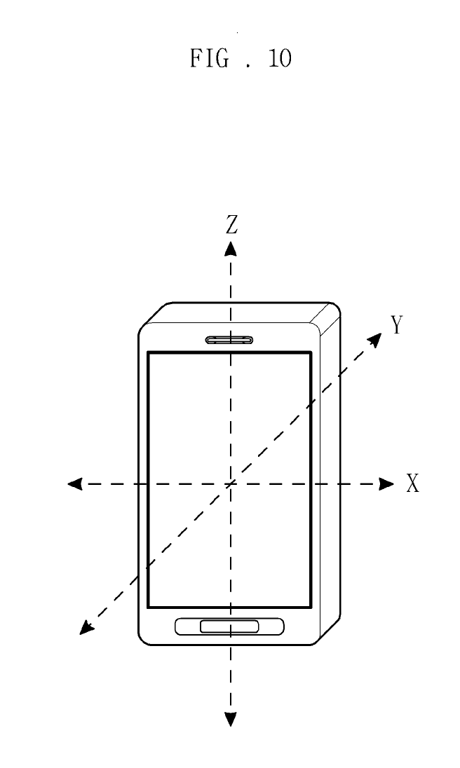

According to the first exemplary embodiment, the screen displayed on the display unit 240 is shown in FIG. 9A. The controller 260 controls the display unit 240 to display the user's hand gripping the portable terminal and a moving image showing the wrist motion. In an exemplary embodiment of the present invention, the display unit 240 may further display an arrow indicating the movement direction of the wrist.

When the user applies the snapping motion according to the screen of the display unit 240, the pattern analyzing part 282 receives raw data from the motion sensor detecting part 220 and recognizes that the user motion has been input (430). After that, the pattern analyzing part 282 analyzes the received raw data and extracts a set of parameter values (440). The set of parameters of the snapping motion may be composed of parameters of motion recognition time, motion intensity, and motion time interval. If the portable terminal is moved along a particular axis, the set of parameters may also include a direction adjustment value as a parameter, where the direction adjustment value refers to a value generated by analyzing the effect of other axes during the movement of the portable terminal in the particular axis.

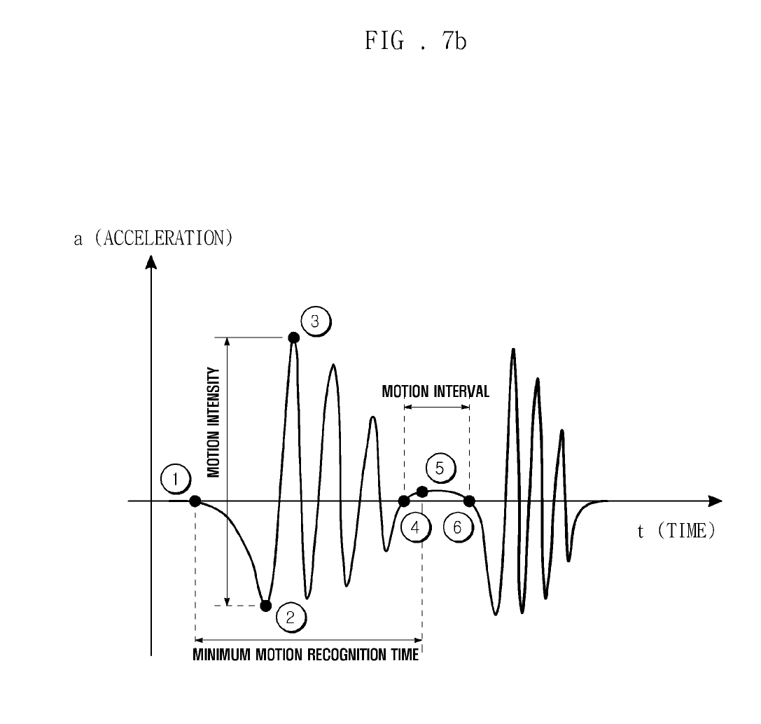

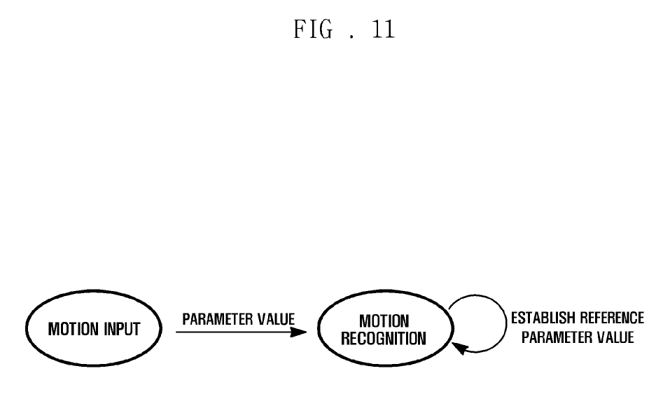

The set of parameters related to the snapping motion is explained with reference to FIG. 7A. FIG. 7A shows a time (t)—acceleration (a) graph when the user repeats the snapping motion twice. Referring to FIG. 10, the time (t)—acceleration (a) graph of FIG. 7A is related to one of the x-, y-, and z-axes along which the portable terminal is moved. The motion intensity is proportion to the magnitude of the acceleration. The motion intensity is measured by the difference between the accelerations at points ‘2’ and ‘3’ shown in FIG. 7A. The motion recognition time is measured using the time interval between points ‘1’ and ‘5’. The motion time interval is measured by the time interval between points ‘4’ and ‘6’. If the time (t)—acceleration (a) graph of FIG. 7A is related to the x-axis shown in FIG. 10, a direction adjustment value can be measured by analyzing the effects of the y- and z-axes during the movement of the portable terminal in the x-axis. As shown in FIG. 7A, the motion recognition time is measured by only the initial motion recognition time as a parameter.

The pattern analyzing part 282 determines whether the number of the extracted sets of parameter values, n, is consistent with a predetermined number of the sets of parameter values, N, (450). The pattern analyzing part 282 analyzes raw data received from the motion sensor detecting part 220 and determines whether the pattern corresponds to a snapping motion. The set of parameter values can be extracted with respect to motions determined as snapping motions. In an exemplary embodiment of the present invention, the sets of parameter values with respect to motions, determined as a user's effective input, are sorted from among the sets of parameter values extracted from the snapping motions, and then output to the pattern learning part 284.

When the snapping motion has been input, the display unit 240 displays the next snapping motion. The display unit 240 can repeatedly display the same motion during the process of learning a snapping motion. The display unit 240 can also display change in the snapping motion states (motion direction, motion velocity, motion distance) while displaying one grip on the portable terminal. The display unit 240 can further display the portable terminal with different gripping methods. When the user grips the portable terminal using different gripping methods, the pattern analyzing part 282 can extract the sets of parameter values according to respective cases. For example, if the display unit 240 displays motions where the left hand grips and snaps the portable terminal and then the right hand grips and snaps it, the pattern analyzing part 282 can extract the sets of parameter values by distinguishing between the left hand and the right hand. The display unit 240 can also display the portable terminal differing in the frequency of snapping motions. The pattern analyzing part 282 can distinguish and extract the sets of parameter values according to the frequency of snapping motions.

The user sequentially applies snapping motions to the portable terminal according to the screen of the display unit 240 until the number of extracted sets of parameter values is equal to the predetermined number of sets of parameter values.

If the controller 260 ascertains that the number of the extracted sets of parameter values, n, is consistent with a predetermined number of the sets of parameter values, N, at 450, it terminates displaying the snapping motion and allows the pattern analyzing part 282 to output the extracted sets of parameter values to the pattern learning part 284. The pattern learning part 284 receives the sets of parameter values and establishes a set of reference parameter values (460). The pattern learning part 284 establishes the set of reference parameter values using the average, maximum, minimum etc. of respective parameter values contained in the sets of parameter values received from the pattern analyzing part 282. That is, if the set of parameter values includes parameters, such as motion intensity, motion recognition time, motion time interval, and direction adjustment value, the pattern learning part 284 establishes a set of reference parameter values using the average, maximum, and minimum of the motion intensity, motion recognition time, motion time interval, and direction adjustment value.

In an exemplary embodiment of the present invention, the pattern learning part 284 analyzes a distribution graph of the respective parameter values included in the sets of parameter values received from the pattern analyzing part 282, sorts parameter values densely distributed in the distribution graph, and establishes a set of reference parameter values using the sorted parameter values.

The controller 260 stores the established set of reference parameter values in the storage unit 230 and then terminates the learning process (470).

After that, if the user inputs a snapping motion to the portable terminal in a user motion recognition mode, the pattern analyzing part 282 extracts a set of parameter values from the input snapping motion, compares the extracted set of parameter values with the set of reference parameter values in the storage unit 230, and then recognizes the user's snapping motion. Comparison between the extracted set of parameter values and the set of reference parameter values is performed by comparing parameter values (motion intensity, motion recognition time, motion time interval, direction adjustment value, etc.) contained in the sets of parameter values, respectively.

If the set of reference parameter values is established as the lower threshold of a motion recognition range, the pattern analyzing part 282 can recognize motions if the input user motion has a value equal to or greater than the lower threshold. If the set of reference parameter values serves as a reference value to determine the upper and lower thresholds of a motion recognition range, the pattern analyzing part 282 can recognize user motions if the input user motions have a value between the upper and lower thresholds. If the pattern analyzing part 282 has recognized user motions, it outputs them to the function performing part 270. The function performing part 270 performs functions corresponding to the user motions recognized by the pattern analyzing part 282.

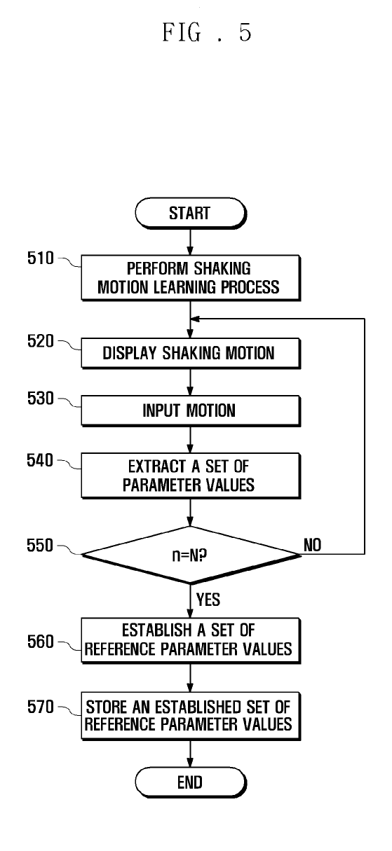

FIG. 5 is a flow chart describing a motion learning process related to a shaking motion during the user motion recognition, according to a first exemplary embodiment of the present invention.

Referring to FIG. 5, when a user inputs a command for executing a shaking motion learning process to a portable terminal, the controller 260 executes the shaking motion learning process (510). In an exemplary embodiment of the present invention, if the user inputs the command for executing a motion learning process, the controller 260 controls the display unit 240 to display a screen allowing the user to select a motion connected to a learning process. In this case, the user can select one of the tapping, snapping, and shaking motions.

When the shaking motion learning process is executed at 510, the controller 260 controls the display unit 240 to display a screen showing the execution of the shaking motion (520). The user inputs a shaking motion according to the screen displayed on the display unit 240.

According to the exemplary embodiment, the screen displayed on the display unit 240 is shown in FIG. 9B. The controller 260 controls the display unit 240 to display the user's hand gripping the portable terminal and a moving image showing the wrist motion. In an exemplary embodiment of the present invention, the display unit 240 may display an arrow indicating the movement direction of the wrist and also display a number or frequency of shaking motion with a phrase such as ‘please shake five times.’

When the user applies the shaking motion according to the screen of the display unit 240, the pattern analyzing part 282 receives raw data from the motion sensor detecting part 220 and recognizes that the user motion has been input (530). After that, the pattern analyzing part 282 analyzes the received raw data and extracts a set of parameter values (540). The set of parameters of the shaking motion may be composed of parameters of motion recognition time, motion intensity, and motion time interval. If the portable terminal is moved along a particular axis, the set of parameters may also include a direction adjustment value as a parameter, where the direction adjustment value refers to a value generated by analyzing the effect of other axes affected by the movement of the portable terminal in the particular axis.

The set of parameters related to the shaking motion is explained with reference to FIG. 7B. FIG. 7B shows a time (t)—acceleration (a) graph when the user repeats the shaking motion twice. Referring to FIG. 10, the time (t)—acceleration (a) graph of FIG. 7B is related to one of the x-, y-, and z-axes along which the portable terminal is moved. The motion intensity is proportion to the magnitude of the acceleration. The motion intensity is measured by the difference between the accelerations at points ‘2’ and ‘3’ shown in FIG. 7B. The motion recognition time is measured using the time interval between points ‘1’ and ‘5’. The motion time interval is measured by the time interval between points ‘4’ and ‘6’. If the time (t)—acceleration (a) graph of FIG. 7B is related to the x-axis shown in FIG. 10, a direction adjustment value can be measured by analyzing the effects of the y- and z-axes during the movement of the portable terminal in the x-axis. As shown in FIG. 7B, the motion recognition time is measured by only the initial motion recognition time as a parameter.

The pattern analyzing part 282 determines whether the number of the extracted sets of parameter values, n, is consistent with a predetermined number of the sets of parameter values, N, (550). When the user motion has been input, the display unit 240 can repeatedly display the input motion that requests an input to display the next motion. The display unit 240 can also change and display the shaking motion with different motion states and one grip position of the portable terminal. For example, the display unit 240 can display the portable terminal changing the velocity of the shaking motion or changing the radius of the shaking motion. The display unit 240 can display the portable terminal changing the direction of the shaking motion. The display unit 240 can further display the portable terminal with different gripping methods. The display unit 240 can also display the portable terminal differing in the frequency of shaking motions.

The user sequentially applies shaking motions to the portable terminal according to the screen of the display unit 240 until the number of extracted sets of parameter values is equal to the predetermined number of sets of parameter values. If the controller 260 ascertains that the number of the extracted sets of parameter values, n, is consistent with a predetermined number of the sets of parameter values, N, at 550, it terminates displaying the shaking motion and allows the pattern analyzing part 282 to output the extracted sets of parameter values to the pattern learning part 284. The pattern learning part 284 receives the sets of parameter values and establishes a set of reference parameter values (560). The pattern learning part 284 establishes the set of reference parameter values using the average, maximum, minimum etc. of respective parameter values contained in the sets of parameter values received from the pattern analyzing part 282.

The controller 260 stores the established set of reference parameter values in the storage unit 230 and then terminates the learning process (570).

After that, if the user inputs a shaking motion to the portable terminal, using the motion sensor 210, in a user motion recognition mode, the pattern analyzing part 282 compares the set of parameter values, acquired from the input shaking motion, with the set of reference parameter values in the storage unit 230, and then recognizes the user's shaking motion. Comparison between the acquired set of parameter values and the set of reference parameter values is performed by comparing parameters (motion intensity, motion recognition time, motion time interval, direction adjustment value, etc.) contained in the acquired set of parameter values and the set of reference parameter values, respectively.

If the set of reference parameter values is established as the lower threshold of a motion recognition range, the pattern analyzing part 282 can recognize motions if the input user motion has a value equal to or greater than the lower threshold. If the set of reference parameter values serves as a reference value to determine the upper and lower thresholds of a motion recognition range, the pattern analyzing part 282 can recognize user motions if the input user motions have a value between the upper and lower thresholds. If the pattern analyzing part 282 has recognized user motions, it outputs them to the function performing part 270. The function performing part 270 performs functions corresponding to the user motions recognized by the pattern analyzing part 282.

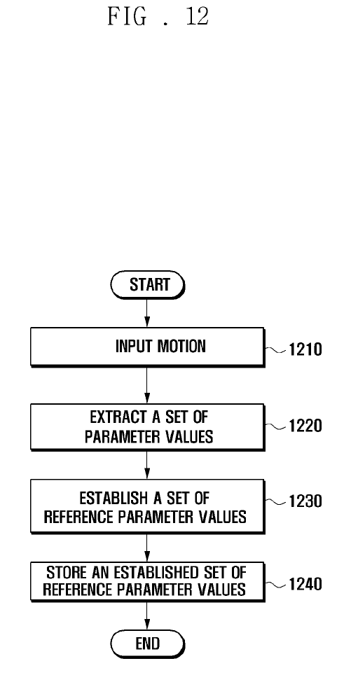

FIG. 11 is a view describing a concept of a method for recognizing user motions, according to a second exemplary embodiment of the present invention.

Referring to FIG. 11, when a user inputs a motion to a portable terminal, the portable terminal compares a parameter value, extracted from the input user motion, with a reference parameter value established in the portable terminal, and then recognizes the user motion. The portable terminal recognizes the user motion and simultaneously re-establishes the reference parameter value using the extracted parameter value. The re-established reference parameter value is used as a reference value to recognize a user motion if the next user motion is input.

During the user motion recognition, the portable terminal continues to change the reference parameter value to comply with a user's characteristic motion pattern, thereby enhancing the rate of motion recognition.

FIG. 12 is a flow chart describing a process for establishing a motion recognition reference in the method for recognizing user motions, according to the second exemplary embodiment of the present invention.

Referring to FIG. 12, when a user inputs a motion to the portable terminal, the motion sensor 210 generates raw data with respect to the input user motion. The motion sensor detecting part 220 transfers the generated raw data, received from the motion sensor 210, to the pattern analyzing part 282. The pattern analyzing part 282 receives the raw data from the motion sensor detecting part 220, and recognizes that the user motion has been input (1210).

The pattern analyzing part 282 extracts the sets of parameter values from the raw data (1220). In an exemplary embodiment of the present invention, it is assumed that the input user motion is one of the tapping, snapping, and shaking motions. The storage unit 230 stores data patterns by such types of user motions. The pattern analyzing part 282 extracts the sets of parameter values corresponding to a data pattern by a pattern matching process. The data patterns according to an exemplary embodiment of the present invention are illustrated in FIG. 6A, FIG. 6B, FIG. 6C, FIG. 7A, and FIG. 7B. The graphs shown in FIG. 6A, FIG. 6B, and FIG. 6C correspond to the data pattern of a tapping motion. The graphs shown in FIG. 7A and FIG. 7B correspond to the data patterns of tapping and shaking motions, respectively.

The set of parameters of a tapping motion includes parameters, such as a motion recognition time and a motion intensity. The set of parameters of a plurality of tapping motions further includes a parameter of a motion time interval. The set of parameters may include a parameter of a degree of trembling of the portable terminal when the tapping motion is input into the portable terminal. When the user carries the portable terminal, the portable terminal may determine that a user motion is input into the portable terminal due to the user body movement, without the input of a user motion. When a user motion is input to the portable terminal, the pattern analyzing part 282 analyzes a data pattern with respect to the input user motion and extracts a parameter value indicating the degree of trembling therefrom. The pattern analyzing part 282 employs the parameter value indicating the degree to recognize the user motion. If the parameter value indicating the degree is relatively large, the pattern analyzing part 282 reduces the motion recognition range to avoid recognizing mal-motion. The greater the user movements, the stronger the motion that is intended to be input. If the degree of trembling of the portable terminal is relatively large, its parameter value is adjusted to increase the lower threshold related to the motion intensity, thereby avoiding recognition of the mal-motion.

The sets of parameters related to snapping and shaking motions may include parameters, such as motion recognition time, motion intensity, and motion time interval. If motions, such as a snapping motion, relate to direction, the set of parameters may include a parameter of a direction adjustment value. For example, if the portable terminal is moved in a direction along a particular axis, it is also affected in the other axes, whose effects are indicated by the direction adjustment value, a parameter. Furthermore, a compensation value according to the motion direction may be included in the set of parameters. Since a user can conduct a snapping motion in various directions, the portable terminal may distinguish and recognize the motion directions. Users may weakly or strongly input motions to the portable terminal, according to directions, and according to users' input patterns. A compensation value according to motion directions serves to compensate the weakly input motion in a direction that a user usually inputs weak motions by lowering the motion recognition reference, so that the portable terminal can recognize a weakly input user motion in the direction. Regarding the snapping and shaking motions, the set of parameters may include the degree of trembling, as a parameter, generated when the user input the motions into the portable terminal.

The pattern analyzing part 282 compares the extracted set of parameter values with the predetermined set of reference parameter values and recognizes user motion. That is, when a tapping motion is input into the portable terminal, the pattern analyzing part 282 extracts the set of parameter values related to a tapping motion and compares the extracted set of parameter values with the set of reference parameter values. If the comparison meets a preset condition, the pattern analyzing part 282 notifies the function performing part 270 that a tapping motion has been input. The pattern analyzing part 282 outputs the extracted set of parameter values to the pattern learning part 284. The pattern learning part 284 establishes a set of reference parameter values using the extracted set of parameter values (1230). In an exemplary embodiment of the present invention, the pattern learning part 284 can establish a set of reference parameter values using the extracted set of parameter values when a predetermined number of parameter values is extracted. In this case, it may be required to input a plurality of user motions. Additionally, the pattern analyzing part 282 extracts a set of parameter values each time that a user motion is input. After extracting the predetermined number of sets of parameter values, the pattern analyzing part 282 outputs the extracted sets of parameter values to the pattern learning part 284. The pattern learning part 284 establishes a set of reference parameter values using the extracted sets of parameter values. In an exemplary embodiment of the present invention, the number of sets of parameter values required according to types of user motions may be established.

For example, if the tapping motion, snapping motion and shaking motion require N sets of parameter values, respectively, and a user inputs a tapping motion into the portable terminal, the pattern analyzing part 282 extracts the set of parameter values, stores it in the storage unit 230, and increases the number of extracted set of parameter values related to the tapping motion by one. If a user inputs tapping motions into the portable terminal and thus the number of extracted sets of parameter values related to the tapping motions becomes N, the pattern learning part 284 establishes a set of reference parameter values using the N sets of parameter values stored in the storage unit 230. The pattern analyzing part 282 deletes the sets of parameter values from the storage unit 230, extracts a set of parameter values with respect to a newly input motion, and then stores it in the storage unit 230. If ten sets of parameter values, for example, are extracted to establish the set of reference parameter values, the pattern learning part 284 establishes a set of reference parameter values using the extracted ten sets of parameter values. Subsequent to establishing the set of reference parameter values, if ten new sets of parameter values are extracted, the pattern learning part 284 re-establishes the set of reference parameter values using the ten new sets of parameter values.

In an exemplary embodiment of the present invention, if a new set of parameter values is extracted after the set of reference parameter values has been established, the pattern learning part 284 deletes the first stored one of the sets of parameter values stored in the storage unit 230, and then establishes a set of reference parameter values using the sets of parameter values stored in the storage unit 230, and the extracted set of parameter values. If ten sets of parameter values, for example, are extracted to establish a set of reference parameter values, the pattern learning part 284 calculates the set of reference parameter values. Subsequent to calculating the set of reference parameter values, if one set of parameter values is newly extracted, the pattern learning part 284 deletes the first stored one of the ten sets of parameter values from the storage unit 230, and then establishes a new set of reference parameter values using the remaining nine sets of parameter values and the newly extracted set of parameter values. In this case, each time the pattern analyzing part 282 extracts a set of parameter values, it transfers the extracted set of parameter values to the pattern learning part 284. Similarly, each time the pattern learning part 284 receives an extracted set of parameter values, the pattern learning part 284 also re-establishes the set of reference parameter values.

In an exemplary embodiment of the present invention, the reference parameter values can be re-established using the extracted set of parameter values and a predetermined set of reference parameter values. For example, in a condition where a reference parameter value with respect to motion intensity is established as 1 gram, and the number of parameter values required to establish the reference parameter value is ten, if a user applies a motion whose intensity is 1.5 gram, the pattern learning part 284 subtracts 1 gram from 1.5 gram to acquire 0.5 gram, divides 0.5 gram by 10 to acquire 0.05 gram, and reflects 0.05 gram to 1 gram, thereby re-establishing the reference parameter value related to the motion intensity to 1.05 gram.

The set of reference parameter values can be established by the average, maximum, minimum, etc. of respective parameter values contained in the extracted sets of parameter values. It can also be established using the distribution graph of parameter values.

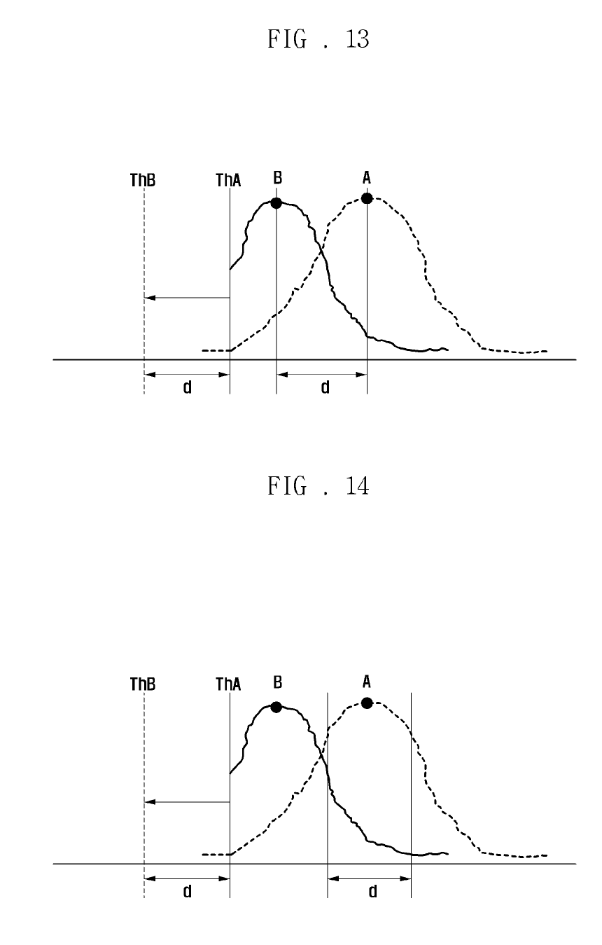

FIG. 13 is a view illustrating a distribution graph of the motion intensity according to an exemplary embodiment of the present invention.

Referring to FIG. 13, the dotted line curve denotes the distribution graph of a motion intensity expected when a user inputs a motion. The solid line curve denotes the distribution graph of a motion intensity with respect to a real input motion. It is assumed that a predetermined reference parameter value is a motion intensity value corresponding to point ‘A’ and an altered reference parameter value is a motion intensity value corresponding to point ‘B’.

The pattern learning part 284 analyzes the distribution graph (solid line curve) of a motion intensity value extracted from a user motion, and establishes a motion intensity value corresponding to point ‘B’ as a reference parameter value. After that, the pattern learning part 284 calculates the difference ‘d’ of the motion intensity value between points ‘A’ and ‘B’ and uses the calculated difference ‘d’ to establish the lower threshold. The lower threshold is changed from motion intensity at point ThA to motion intensity at point ThB. The lower threshold may be re-established by comparing the shape of a solid line curve with that of a dotted line curve.

If the motion intensity value corresponding to point ThA is established to a reference parameter value before being altered and the motion intensity value corresponding to point ThB is established as a new reference parameter value, the pattern learning part 284 establishes a lower threshold using the reference parameter value. That is, the reference parameter value becomes a lower threshold.

If a user motion with a motion intensity value, equal to or less than a lower threshold is input into the portable terminal, the pattern analyzing part 282 extracts a set of parameter values and reflects it to the reference parameter value. For example, if a user inputs a tapping motion into a portable terminal, with a relatively weak intensity, the pattern analyzing part 282 may not detect the input tapping motion. In that case, the pattern analyzing part 282 extracts at least one parameter value, such as a motion intensity value, etc., and then stores it in the storage unit 230. If the pattern analyzing part 282 continues to receive user motions whose types cannot be identified and thus extracts the predetermined number of parameter values, it transfers the extracted parameter values to the pattern learning part 284, so that the pattern learning part 284 can reflect the received parameter values to the establishment of the set of reference parameter values. For example, if the pattern learning part 284 continues to receive user motions whose types cannot be identified, it establishes a low reference parameter value, so that the pattern analyzing part 282 can recognize a user motion with a relatively weak intensity. The controller 260 establishes a set of reference parameter values and then stores the established set of reference parameter values in the storage unit 230 (1240).

As described above, the method and portable terminal, according to the present invention, can learn user's characteristic motion patterns and apply the learning result to the motion recognition process, thereby enhancing a rate of user motion recognition. The method and portable terminal can analyze user's characteristic motion patterns and establish a motion recognition reference value each time the user motion is input, thereby enhancing the recognition rate of user motions.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for recognizing a user motion in a portable terminal comprising a motion sensor, the method comprising:
extracting at least one parameter value in response to at least one user motion being applied to the portable terminal, the at least one user motion being detected by the motion sensor;
establishing a reference parameter value serving as a user motion recognition reference, based on the extracted at least one parameter value; and
storing the established reference parameter value.

2. The method of claim 1, further comprising:
recognizing, in response to an input user motion, the input user motion based on the stored established reference parameter value.

3. The method of claim 2, wherein recognizing the input user motion comprises:
setting the stored established reference parameter value as a lower threshold; and
recognizing the input user motion equal to or greater than the lower threshold.

4. The method of claim 2, wherein recognizing the input user motion comprises:
establishing a lower threshold and an upper threshold for motion recognition based on the stored established reference parameter value; and
recognizing the input user motion if the input user motion is in a range from the lower threshold to the upper threshold.

5. The method of claim 1, further comprising:
requesting an input motion by displaying an example of the requested input motion.

6. The method of claim 1, wherein extracting the at least one parameter value comprises extracting a parameter value of one input user motion that is of one or more input user motions, wherein the extracted parameter value satisfies a preset condition.

7. The method of claim 6, further comprising:
extracting a parameter value of one input user motion that is of one or more input user motions, wherein the extracted parameter value does not satisfy the preset condition.

8. The method of claim 1, wherein extracting the at least one parameter value comprises:
detecting a plurality of user motions applied to the portable terminal; and
extracting a number of parameter values from the plurality of detected user motions.

9. The method of claim 8, wherein establishing a reference parameter value comprises:
using at least one of the maximum, the minimum, and the average of the extracted parameter values.

10. The method of claim 1, wherein the at least one user motion applied to the portable terminal is one of a tapping motion, a snapping motion, and a shaking motion.

11. The method of claim 10, wherein, the at least one user motion corresponds to the tapping motion, and the extracted at least one parameter value corresponds to at least one of motion intensity, motion recognition time, motion time interval, and degree of trembling when the at least one user motion is input.

12. The method of claim 10, wherein, the at least one user motion corresponds to the snapping or shaking motion, and extracting the at least one parameter value comprises:
distinguishing a type of snapping or shaking motion and a style of gripping the portable terminal.

13. The method of claim 10, wherein, the at least one user motion corresponds to the snapping or shaking motion, and the at least one parameter value corresponds to at least one of motion intensity, motion recognition time, motion time interval, direction adjustment value, degree of trembling when the at least one user motion is input, and compensation values by motion directions.

14. A portable terminal to recognize a user motion, comprising:
a motion sensor to sense a motion applied to the portable terminal, to generate a sensed signal in response to the applied motion, and to output the sensed signal;
a pattern analyzing part to receive the sensed signal, and in response to the sensed signal, to extract a parameter value of a user motion applied to the portable terminal;
a pattern learning part to establish a reference parameter value using the extracted parameter value; and
a storage unit to store the established reference parameter value.

15. The portable terminal of claim 14, further comprising:
a display unit to display an example of a user motion that is requested as an input.

16. The portable terminal of claim 14, wherein the pattern analyzing part is operable to recognize the user motion applied to the portable terminal based on the established reference parameter value stored in the storage unit.

17. The portable terminal of claim 14, wherein the pattern analyzing part is operable to extract at least one of motion intensity, motion recognition time, and motion time interval in response to the user motion applied to the portable terminal corresponding to a tapping motion, and is operable to extract at least one of motion intensity, motion recognition time, motion time interval, and direction adjustment value in response to the user motion applied to the portable terminal corresponding to a snapping or shaking motion.

18. The portable terminal of claim 14, wherein the pattern learning part is operable to establish a reference parameter value using at least one of the maximum, the minimum, and the average of a plurality of extracted parameter values.
